(19) United States
(12) Patent Application Publication
(10) Pub. No.: US 2007/0243509 A1
(43) Pub. Date: Oct. 18, 2007

(54) System and method for electronic media content delivery

(76) Inventor: Jonathan Stiebel, Brighton, MA (US)

Correspondence Address: KUTA INTELLECTUAL PROPERTY LAW, LLC, P.O. BOX 380808, CAMBRIDGE, MA, 02238, US

(21) Appl. No.: 11/731,083

(22) Filed: Mar. 30, 2007

Related U.S. Application Data
(60) Provisional application No. 60/787,962, filed on Mar. 31, 2006.
(60) Provisional application No. 60/799,093, filed on May 10, 2006.

(51) Int. Cl. G09B 19/00

(52) U.S. Cl. 434/236

(57) ABSTRACT

On on-line music community device composed of a plurality of stakeholders selected from the group of Musicians, Listeners, Labels, Broadcast Media, Contextual advertisers, electronic distribution channels, physical distribution channels, cable broadcast, retail stores. A music tracking device whereby said music tracking device is operative to track listener music playing behavior, regardless of whether said device is continuously connected to the Internet, and independent of the media player program used.

### CROSS-REFERENCES

This application claims priority of U.S. provisional application Ser. No. 60/787,962 filed Mar. 31, 2006 and titled, “System and Method for Operation on Music Preference” by the present inventor, and U.S. provisional application Ser. No. 60,799,093 filed May 10, 2006 and titled, “System and Method for Operation on Music Preference,” the content both of which are hereby incorporated in the entirety.

### BACKGROUND

Developments in media production and delivery technologies have increased the amount and availability of media content of all types such as music and video. With this proliferation of media content and associated choices, the consumer is challenged in discovering new media content. The conventional delivery routes, such as broadcast radio play, do not keep up with the deluge of new content. Other conventional discovery routes, such as published reviews, have always been a somewhat inaccurate way to provide a consumer with information about new media content.

Media production companies such as record companies and movie companies face the challenge of attempting to profit in the uncertain industry of entertainment. Conventional business models for marketing media content are failing to provide sufficient return on investment.

The developments in media production have enabled producers of media content such as musicians to more easily produce new content. Developments in delivery technology have also provided media producers more delivery venues of new media content. The challenge to attract consumer attention, however, has also increased. The somewhat associated challenge of obtaining support, such as financial support, to continue producing new media content remains difficult for media producers.

Conventional solutions to the challenges include the hiring of experts to analyze music and provide opinions about the potential success of particular media. Other conventional methods of determining popular music include in vitro focus group, on-site tracking and hiring musicians to rate music. In vitro focus groups and on-site tracking ask people in captivity what they think they like and tracks their behavior in captivity. In vitro call-outs ask people what they what to hear, and historical purchase data fails to enable the record labels to accurately predict future sales. Conventional ratings methods typically suffer from a disconnection between what people say and what they do, especially with regard to musical taste.

In sum, record labels spend billions of dollars backing music where only a small percentage of music is commercially successful. The music industry currently includes four major labels and over 700 independent labels. There are over 400,000 unsigned bands seeking to gain spots in the 27,000 annual music releases which in turn vie for an estimated 2,700 slots in radio airplay. The traditional model of the music industry use is in crisis where only 10% of released music is profitable. At the same time, unsigned artists face tremendous challenges getting their music heard and adopted by even independent labels. The labels employing current technology are not able to improve their selection of music and targeting of marketing dollars. Broadcast radio is generally unwilling to take risks to discover new broadcast quality music and accordingly has lost variety that listeners seek. Musicians struggle to be heard by listeners who will like their music. Further, musicians generally lack support including financial support for their creativity. Listeners are confronted with an overwhelming array of choice and few effective tools to find media they like.

It remains desirable to have a system and a method for enabling seekers of new media content to reliably find new media content they will like or in which they will have some interest.

### SUMMARY

The present invention is directed to a system and method for electronic media content delivery.

The system and method for an on line music community focus on enabling quality musicians to be discovered by leveraging the participation of musicians, listeners, and disk jockeys for the benefit of a wide variety of music industry stakeholders.

According to one embodiment of the invention, a system tracks actual listener and musician behavior. Based on that behavior, the system classifies music and the music community in a way that the act of correct classification directly benefits the classifier, and an act of incorrect classification penalizes that classifier. The system then uses these classifications to predict broadcast quality, and music sales profitability. The predictions enable music marketers such as musicians and/or labels to better segment their marketing budgets. The segmentation enables contextual advertising to purchase exposure on the system based on particular songs, for music, or a mixture of listener behavior, listener ranking, and musician ranking for any contextual advertiser.

By learning what people choose to hear and how musicians classify their music relative to their peers, and how listeners rely on others for recommendations, the pattern of music success and market spreading mechanisms becomes accessible to the system to predict music purchase patterns and classifying music as profitable or not profitable.

Using conventional marketing techniques, 90% of music CD releases are not profitable. Record labels spend prodigiously in marketing new music albums every year. Yet, only approximately 10% of those albums are profitable enough to recover costs of recording, production, distribution, and promotion. Record labels already invest over 10% of their marketing budget in market research which typically does not provide accurate information in predicting what music will sell. Record labels can save money on marketing and development (“M&D”) expenditures by avoiding unprofitable releases or marketing in regions that support an album.

Embodiments of the present invention apply user listening behavior in assessing album profitability. One of the embodiments of the invention includes a web site that forms an online music community. The present invention provides predictive, statistically significant audience feedback to record labels before an album's release. The feedback is useful for screening unprofitable music releases before investing in extensive M&D.

Embodiments of the present invention bring together record labels, listeners, and artists. Listeners discover new prerelease label music and rising unsigned artists vying for recognition. This new music streams to listeners who replay, skip, rate, and recommend songs to community members. Unsigned artists post music to gain audience support and label attention.

Listeners are known to discover non-mainstream music recommended by the behavior of people whose music tastes they trust, such as lead listeners, disc jockeys, and musicians. The system attracts and retains listeners typically depend on three aspects: (a) ease of use of the web-based listener portal, (b) attractive content and (c) music-oriented listener community. To ensure ease of use, the present invention enables automatic listener customization of the listening experience, rapid navigation between songs they like to hear, and effective new music discovery methods. To ensure an attractive music offering, the present invention provides pre-release and unsigned content and actively distributes music to listeners in accordance with listener customized tastes. To build a music-oriented listener community, the present invention provides social networking opportunities with fellow listeners who share similar music listening behavior. Listeners belong to groups based on actual listener musical tastes. Listeners explicitly recommend music to others who follow their music tastes, which facilitates a dialogue around music. Listeners explicitly specify community members whose music tastes they trust. Listeners are further encouraged by receiving free downloads of music upon commercial release based on credits built up by active participation and activity while listening.

The present invention includes a combination of predictive-album profitability, new music, data gathering and analysis, and targeted advertising. By tracking listener behavior over various moods and settings, data collected by the present invention captures user listening day after day, song by song.

Embodiments of the present invention include is a computerized database product that detects, collects, and organizes information on what people choose to hear. This type of data collection is referred to herein as “in vivo data collection.” In vivo data collection provides critical music listening preference and usage data to the music industry—to increase music sales and reduce marketing expenses. The computerized database detects, collects, and organizes information on what people choose to hear. In embodiments of the present invention, a small footprint software wrapper enveloping electronically and physically distributed music files that a user downloads to a listening device such as a computer or a portable music player. A user plays a song contained by the software. The software reports on the listener behavior and on all music files present on the listening device to a database when devices connect to the system over a network such as the Internet.

A database according to embodiments of the present invention aggregates outputs to feed into the analytic engine for prediction, and a set of resultant predictions for access by the labels and broadcast media. Embodiments of the present invention use historical purchase data, and potentially marketing budget data, to predict future song profitability. Embodiments of the present invention use that data integrated with proprietary behavior tracking data. Accordingly, the present invention increases success of CD releases by providing highly predictive, statistically significant audience feedback to record labels to more accurately choose music that people will buy and what they will listen to between commercials. The predictive power of this technology accelerates radio's adoption of this music. The system works on an opt-in basis when listeners download unsigned singles without expense.

The present invention provides market data for the recording industry by tracking the momentum of all distributed music. The present invention also provides critical marketing data to music industry decision-makers including record executives, radio programmers, artist managers, music publishers, music licensing companies, retail store managers, independent promoters. Further, the present invention reliably estimates popularity of individual songs using a plurality of metrics including charts showing artist, title, time of day played, length of play, number of times played, device geographic location, and demographics. A prediction database, in one embodiment, is an Oracle-based application available over the Internet to paid subscribers. Other databases suitable for use with the present invention are available. The present invention is not limited to Oracle databases.

Knowing what people choose to hear focuses marketing push in the areas where purchases are followed by listening, or reducing a push when purchases simply sit on the shelf of the end-user. Also, knowing what people choose to hear enables tailoring live performances, or other products complementary to new music singles, of a particular artist or genre in a geographic region based on listening patterns and facilitates direct communication channel with the fans.

Embodiments of the present invention provide advertisers a highly targeted advertising medium to reach a diverse set of demographic groups with the common interest of music. By allowing advertisers to target not only a vertically focused site but also where on the site they want to advertise, the present invention commands a higher premium than what advertisement networks charge. A business model, according to the present invention, allows options for advertisers to directly target the site, or for contextual advertisement networks (e.g. ContextWeb, Chitika, Ezula, Kanoodle, AlmondNet) to place ads on the site. Current contextual advertisement networks generally are not able to target advertisement placements to the detailed level of music interest, but rather targets only on aggregated topics like “hobbies”, of which a subset is music.

The present inventive system enables the music industry to know which songs on a release people actually listen to repeatedly. The present inventive system also enables the record industry to know which markets to target with which music. It enables contextual advertising to promote new releases.

Embodiments of the present inventive system provide a “costly” mechanism for musicians to rank themselves and others, improving reliability, and building music taxonomy to enable world-wide scaling. Rather than relying on poor proxies to determine what people keep listening to by calling and asking, gathering people in a room to ask, or historical purchase data, the present inventive system actually tracks what they continue to listen to over various moods and settings. This data is useful to broadcasters to maintain variety while minimizing risk. Labels and artists want to show that their music is broadcast quality. A label or musician can use the present inventive system to determine which music is broadcast quality and release only that music.

Embodiments of the present inventive system enable the labels to select only songs that people choose to hear, if listeners do not like it, record another for a relatively low cost compared to the current expenditures on marketing and distribution. Embodiments of the system and method can be used to target listeners, demographics, and to frame the campaign message. Listeners discover music they choose to hear.

Embodiments of the present invention includes a system that brings musician peer and self-ranking classification system where each song ranks where it believes it will be most heard. Each song gets a fixed number of points to distribute among songs it wishes to follow. This enables new unsigned artists to be heard.

On song transition, the points bid by a given song divided by the total number of points bid becomes the probability of a transition. (In an alternative, the highest bid wins in a winner-take-all system.) Thus, a song with only a few points bid will be heard by a fixed fraction of listeners. Songs which are not liked have transition path chosen multiplied by a beta between zero and one. This affects that particular user and whether when hearing the previous song, it will again select that same next song.

If a number of listeners all dislike the song played after the transition, that song transition is multiplied by defined value, beta. The scoring affects the global transition probabilities, however the total impact that a given listener may have will be normalized over the listener's feedback. Thus songs that are misplaced or are unpleasant to hear fade from the system over time, and the successful songs rise to the top of ratings charts. In an alternative embodiment of the invention, musicians and labels purchase extra points to help improve a song's chance to be heard on the system.

Further included in the present invention are community and in-vivo tracking. This portion of the music system involves combining ranking data with behavioral data. Sales data may be included as well. Any of these features can be given a non-negative weight and included in the ranking systems described below.

Film makers, advertisers, musicians, and others need music as part of their work product. Whatever the need, the entity desiring music can post a request to buy (“RTB”, also referred to as a “seeker”) music rights for a specific price with desired qualities. Those qualities in various arrangements of the invention include listener behavior, broadcast quality, expected profitability, musician peer ranking, etc. The present system helps refine and define the music qualities being sought. The RTB can be “sanitized”, that is, certain information is redacted, so that competitors will not know the meaning behind the RTB. Once solvers agree to confidentiality they learn the problem definition. Solvers present their proposals. The seeker evaluates proposals. Rights are transferred upon payments. Identity is revealed on payment. The present system takes a commission.

Embodiments of the present invention include in vivo listening behavior tracking, listener peer and self-ranking, musician peer and self-ranking, prediction of broadcast quality, prediction of profitability, targeting of marketing spending, contextual advertising of musicians/labels by influencing initial frequency of playing of certain songs, and contextual advertising by listener behavior, listener ranking, musician ranking, and song.

In operation, the music creator (that is, the “musician”) uploads songs to the present system. The music creator may be either an individual or a group of individuals, i.e., a band. Each of the songs gains a point per verifiable sale. In a first embodiment, sales data is collected from sales through the system. In a second embodiment, sales data is uploaded from an external source and in alternative arrangements from a plurality of external sources. The musician can search among the existing songs and place a probability bid. The probability bid either replaces or modifies the existing probability distribution in a transition matrix. So, a band can bid in proportion to its popularity. As uploaded song gains popularity, the weight of the various bids placed in association with that song can be strengthened by the musician. In one embodiment, bids are strengthen by means of a weighting factor. In this embodiment, each song has a weighting factor assigned by the system. The system determines the weight for a song based on the song's popularity. The weight is adjusted over time if popularity of the song increases. In a first embodiment, popularity is determined from data internal to the system. In a second embodiment, popularity is determined using external data. In a third embodiment, song popularity is determined using a combination of internal and external data. In this way the points bid in association with that song increase in influence in the system.

Embodiments of the present invention provide an expensive behavior rating system where listeners choose music to hear and musicians select music to follow. Trustworthy data originates from (a) what people do rather than what they say, and (b) actions which are costly to the actor to perform and are thus more trustworthy.

Listeners are encouraged to accurately rate the music in the present invention, because the rating system will provide the type of music the listeners claim to like. Musicians are motivated to categorize their music because such categories will drive listeners who they think will like their music. If the listeners do not like that music, the music popularity rating will decline.

The present invention together with the above and other advantages may best be understood from the following detailed description of the embodiments of the invention illustrated in the drawings, wherein:

### DRAWINGS

FIG. 1 is a block diagram of a system according to principles of the invention.

FIG. 2 is a flow chart of the predictive music system according to principles of the invention.

FIG. 3 is a block diagram of the predictive system according to principles of the invention.

FIG. 4 is a flow chart of the operation of the predictive engine in the predictive music system.

### DESCRIPTION

The present invention is directed toward a system that enables media recipients, such as listeners to music, to become easily familiar with new media content and formulates predictions about the potential popularity of new media content. In the present system, an online community ranks new media content. Creators of the content, such as musicians, categorize and upload their media to the system. In embodiments of the system, each media recipient selects a ratio of new media content, such as unsigned and pre-released music. The media recipient selects at least one preferred genre and a starting media piece selected from a database of existing media content. The present system then streams a piece of media content to the user through a playing device, such as a listening device, generally showing a web page for each song where the user is connecting to the system through the Internet. The present system tracks user behavior of the media recipient. The system is able to follow and media recipient activity with regard to the media either while the media recipient is connected to the system through the Internet or when the media recipient is “off-line” using a playing device not connected to the Internet. The system determines a rating for each piece of media content based on media recipient behavior. In alternative embodiments, certain other factors such as data accumulated from “expert” recipients and also from the media creators themselves. The rating indicates potential popularity of the piece of media content.

The following detailed description refers to the accompanying drawings that illustrate embodiments of the present invention. Other embodiments are possible and modifications may be made to the embodiments without departing from the spirit and scope of the invention. Therefore, the following detailed description as well as other detailed description above and throughout the document, is not meant to limit the invention.

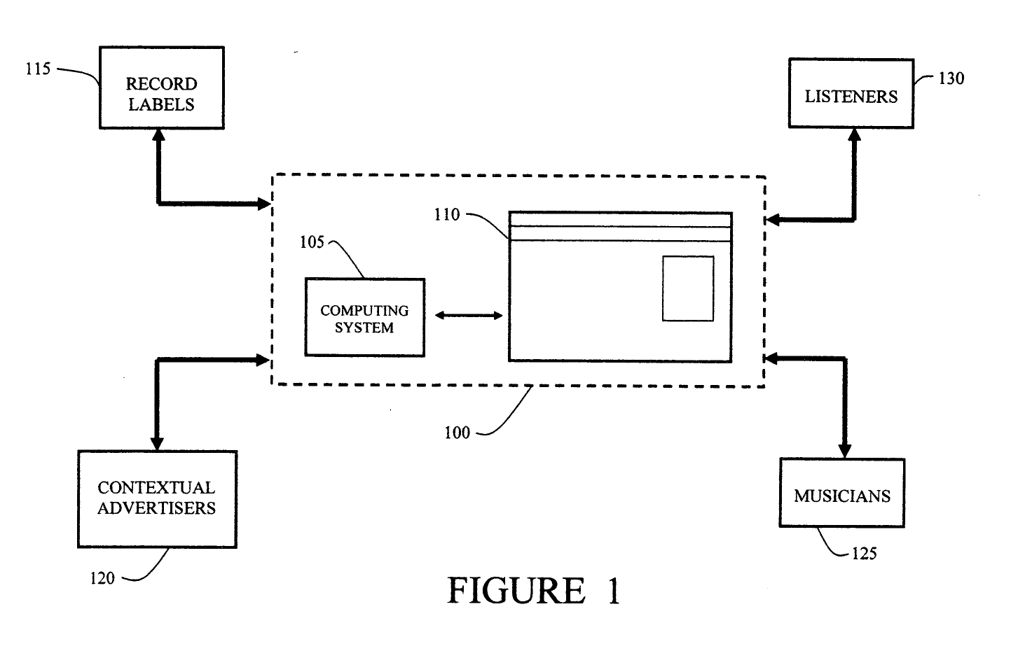

FIG. 1 is a block diagram of an embodiment of the present invention, a system 100 of the present invention and the participating entities. The system 100 generally takes place in a computing system 105 which is typically a conglomeration of controllers, memory and data storage devices. The system 100 in some embodiments further provides a web interface 110 through which the entities participate. The participating entities include record labels 115, contextual advertisers 120, musicians 125, and listeners 130. The system 100, the participating entities 115, 120, 125, 130 and their operation and interaction are described in detail below. Alternative embodiments of the invention include different combinations of participating entities.

The system 100 of the present invention addresses the needs of listeners, musicians, disk jockeys, record labels and contextual advertisers. Musicians are generally defined as any individuals or musical groups who spend more than 10 hours a week in music, and who record songs. A “DJ” is a thought leader to whom others look to determine personal music listening patterns, whether or not that DJ has access to a broadcast medium.

The system 100 of the present invention provides two mechanisms of ratings. (1) Rating per song, which is defined as a rating applied to listener behavior when the listener is listening to that particular song such as stop, or skip actions, or optional listener input such as “favorite”, “love”, “hate”, and so on (2) Rating per transition, whether listeners like certain songs to follow others, this provides a musician posited, listener modified and verified relationship between individual songs.

If, for example, there are approximately fifty (50) listeners for every musician, then even for new unsigned music, the average listeners will be listening to music which some other listener has already rated approximately 98% of the time.

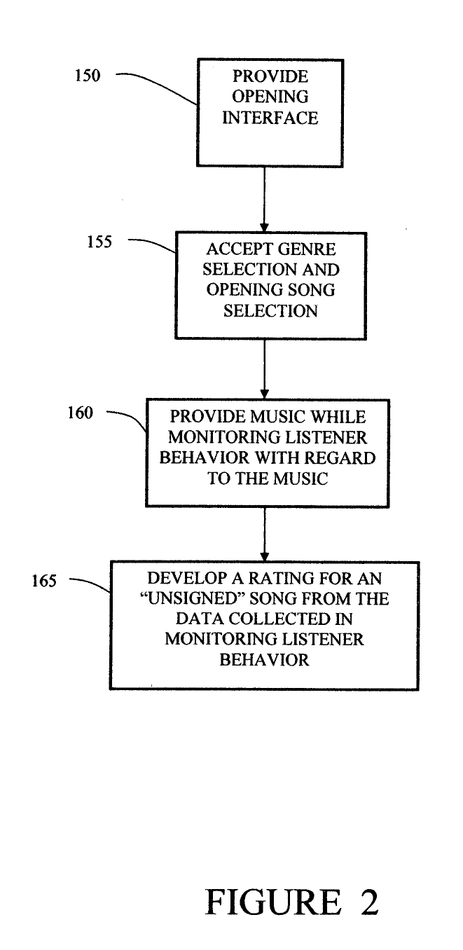

FIG. 2 is a flow chart of the general operation of one embodiment of the present invention. At step 150, the system provides a system interface. Typically, the present system is web-based and so the opening interface is typically a web page that prompts the listener for information. Other computerized systems are also possible within the scope of the invention.

At step 155, the system accepts a genre selection and an opening song selection from the listener. The system uses the genre choice to create a set of music stations to be customized. for the listener. The listener also enters the name of a song or songs to start with. The genre selection provides the system with information to play a broader spectrum of music than selection of a single song. In an alternative embodiment, the listener also selects a thought leader, or a type of thought leader such as someone who really likes that song, someone who really listens to the genre, or someone with similar listening patterns to that listener. The selection of the thought leader enables the system to more-specifically determine how to program a delivery channel to deliver music to the listener. At this step, in one alternative embodiment, the listener specifies an amount of “new” music, for example 30% new music that the listener would like programmed into his or her listening channel. In a further alternative embodiment, the system accepts a selection of favorite artists also in order to further determine music programming to deliver to the listener.

The musician posts music, and specifies which music the posted music should follow. It is an accurate list because the musician exhibits “costly behavior” which will be described below. Each posted song is assigned, for example one hundred points which the musician can distribute as follows. The musician associates one or more of the one hundred points to existing songs in the system as a bid. The bid is a bid for play of the musician's newly uploaded song after the selected existing song. The rating system of the present invention encourages the musician to assign points to songs that are similar to or that are likely to be appreciated by listeners who might like the new song as well.

In one embodiment of the musician ranking system, the system awards a transition from the existing song to a new song according to the highest bid. The present system has one of its objectives to enable musicians to be heard. Accordingly, an alternative embodiment of the system provides a probabilistic transition where the probability of transition to a given song is that song's point bid over the total number of points bid on that transition. Thus, a bid of, for example, ten points when the collection of other song contestants bid ninety points, would transition 10% of the time.

At step 160, the system monitors listener behavior with regard to the music provided to the listener. When a listener hears a song, he or she votes for or against the song based on behavior.

At step 165, the system develops a rating for the new music, also referred to as “unsigned” music based on listener behavior. Listener behavior has two effects (a) it will weaken or strengthen the transition probabilities (that is, transition between songs), as this song may not be well suited to follow the previous song—or it may be complementary, and (b) it will decrease or increase the popularity of the given song. In an alternative embodiment of the system, the factors used to determine a rating including one or more of the following: the song itself, listener behavior as described above and further including the number of listens to the song, the time spent listening, the number of listeners and sales data.

The present system builds up a community peer music classification system seeded by musicians and determined by listeners, operative to classify music by what people like to hear together. Moreover, the system determines individual song popularity determining what music people choose to hear. The present inventive system is built up around a collection of “costly” or “expensive” behavior. A costly behavior is one that the human will pay a price if that behavior is inaccurate. For example, the peacock will be eaten by predators if it was not strong enough to warrant carrying such large features.

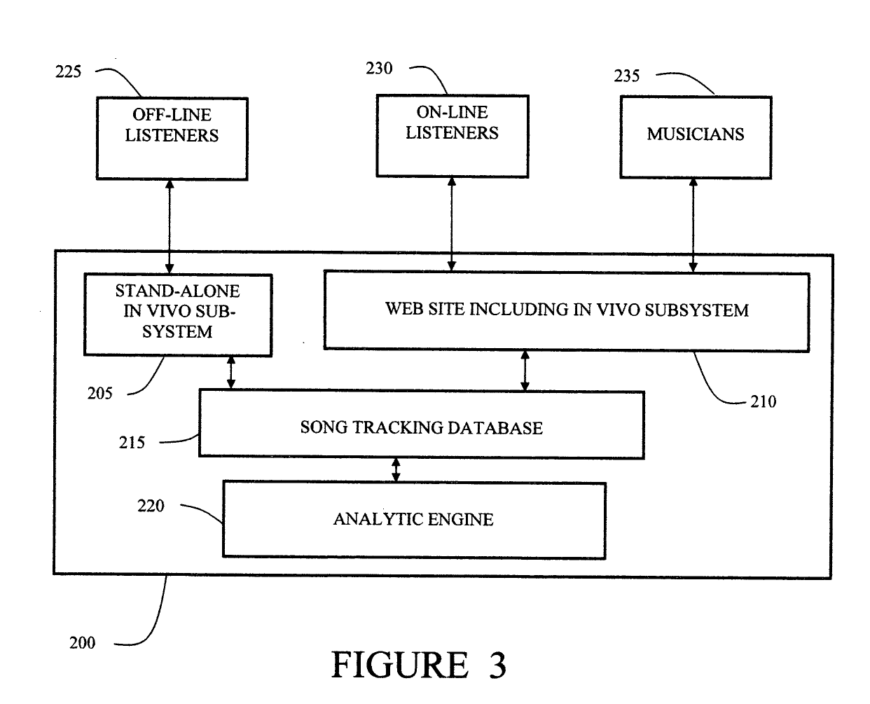

FIG. 3 is a block diagram of one embodiment of the present invention. The predictive system 200, also referred to as the predictive engine, includes a stand-alone in vivo subsystem 205, a web site 210 including an in vivo subsystem, a song tracking database 215 and an analytic engine 220. The stand-alone in vivo subsystem 205 is typically a software application that can be downloaded onto a user's portable listening device. The application monitors listener behavior with regard to the music on the listening device. The collected data is uploaded to the predictive system 200 when the portable listening device is connected to it. The web site 210 also includes an in vivo subsystem to monitor listener behavior. The in vivo subsystem 205 and web site 210 are connected to a song tracking database 215. The song tracking database 215 stores the music to be played to the listeners, both music with established popularity and also “new” music, that is, music whose popularity is not yet established. The “new” music is also referred to as “unsigned” music and “prerelease” music. The song tracking database 215 also stores, in association with the various songs, bid points and ratings. The bid points and ratings are described in greater detail below. The song tracking database 215 is connected to an analytic engine 220 which analyzes listener behavior data collected by the in vivo subsystem. The analytic engine 220 in one embodiment is a type of machine learning device. Generally, the analytic engine 220 is trained and tested on pre-existing data. As the analytic engine 220 operates the system, the analytic engine 220 gathers more data from which it “learns” and so, over time, becomes ever more effective in determining ratings for the various songs to be analyzed by the predictive system 200.

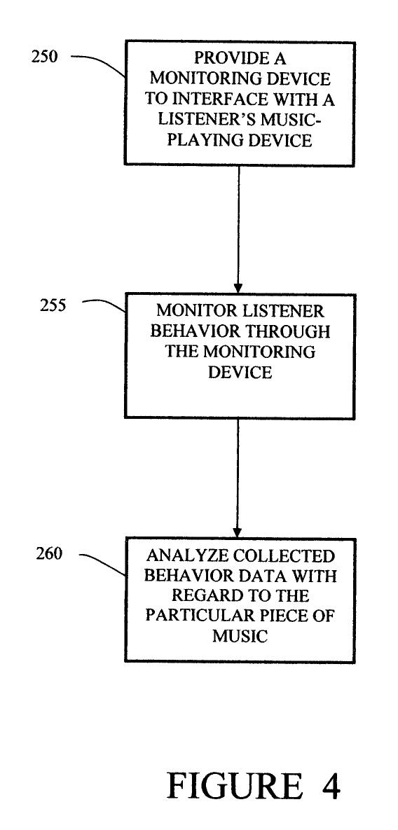

FIG. 4 is a flow chart of the general operation of the system and particularly the predictive engine.

At step 250, the system provides a monitoring device to interface with a listener's music-playing device. In one embodiment, the monitoring device is a software application that can be downloaded to a music player. In another embodiment, the monitoring device is a hardware device that communicates with a music player. In yet another embodiment, the monitoring device is a web-based application that is included in a web page interface for streaming music.

At step 255, the system monitors listener behavior through the monitoring device. In this step, the predictive system collects data from listeners. The collected data includes listener behavior related to particular pieces of music and listener behavior with regard to transitions between pieces of music.

At step 260, the predictive system analyzes the collected behavior data with regard to particular pieces of music. The results of the analysis include the potential popularity of the particular piece of music. Further results include particular members of an audience who would receive the particular piece of music favorably. This enables the system to provide particular listeners with new music in a directed way that is likely to be successful.

In the present system, when the listener continues to listen to a particular piece of music following another one, the listener's behavior indicates that the transition from a first song to a next song was good. The listener hears a piece of music played if it was given a positive behavior-based rating. Conversely, when the listener's behavior indicates the transition is not good, the play of the second song after the first song is reduced or eliminated from that listener's listening channel. If the listener's behavior indicates he or she does not what to hear the song, it will decrease the chance he or she will hear that song on the listening channel.

Likewise, the musician ranking system is an “expensive behavior” as the musician is encouraged by the system to focus on a listener-friendly music classification method. Choosing a popular yet not yet discovered song to follow will enable a high chance the lead song will be heard followed by a good chance the musician's song will also be heard. Selecting a song which is already discovered and popular may cause the chance to follow to be very low. Trailing a song which is popular but of an incompatible style or genre, may lead to attracting listeners who will degrade the transition rating (thus effectively wiping out the mistake of the musician), but not without giving the song a very unpopular rating. So, the musicians have an incentive to balance exposure and popularity in selecting the songs to follow.

Moreover, when the listener selects a thought leader (e.g. DJ) whether such a thought leader is a known personality, or a class of person such as someone who specializes in a particular song, or genre, or alternatively, has a similar collection of listening tastes to the listeners, that behavioral rating is expensive in the sense that the listener will be streamed music based on that particular thought leader. Thus, the system of the present invention provides a reliable ranking of thought leaders and types of thought leaders. The listeners can exchange information between themselves on recommendations for thought leaders.

Typically, the thought leader pool is seeded with conventional disk jockeys from radio and broadcast media. Those people generally considered to be leaders in the field of music tastes are selected to be the DJs. Listeners also behaviorally rate other listeners. From this, a core listener set and a periphery listener set develop—much as in open source communities. Those core listeners become thought leaders (or DJs) as well. Through all the above-described costly rating and selection systems, system of the present invention learns what music people choose to hear and which songs should follow one another.

When a listener wishes to download a song, the listener is informed that the system seeks to learn the listener's true music tastes in vivo. Thus, the system installs in vivo music tracking software (described below) on the listener's CPU-based device a first time (and, if necessary, later) the listener asks to download music. The listener wants the system of the present invention to learn the listener's music tastes while the listener is busy with other things. The in vivo software enables tuning to a particular listening channel, or “station.”

The in vivo tracking system of the present invention is operative to track listeners in their natural setting over a variety of moods. The person could be working out in the gym—contextual advertisements can be targeted to athletic products, or outside chopping wood—contextual advertisements can be targeted to a new hatchet, or enjoying a quiet romantic dinner—contextual advertisements can be targeted to fine wine. It can reach listeners based on the song and their mood.

Embodiments of the present invention provide basic community services without charge to the musician and listener communities, when selling the results of the behavioral listening and ranking data to the record labels. Record labels provide pre-release music, and the present system learns whether people play the music, how musicians and listeners categorize the music, and in what geographic region to sell the music. The system of the present invention identifies new and likely-to-be-popular artists through musician bidding and through listener behavior.

In another embodiment of the present invention, a method assigns importance ranks to nodes in a linked database. The database is for example a database of entertainment media with associated citations, whether in a world-wide-web format or in any hypermedia database. The rank assigned to a piece of entertainment media is calculated from the ranks of entertainment media that “cite it.” Unlike the Internet, each piece of entertainment media embodies “citations” which point from the “cited” entertainment media item to the citing entertainment media. A link placer places a link from an existing node thereby “citing” it. For example, when a musician classifies her music, she does so by listing bands or songs that she wishes to open for, but those bands or songs may not necessarily have any input into who opens for them. The method is particularly useful to enable efficient music search by listening, or entertainment search by viewing. Musicians classify their music relative to previously existing music.

The method of classification can be described using a graphic-theoretic metaphor as link placers, and the listeners can be described as link traversers. In the metaphor, the nodes are songs, the links are probability transitions from song to song, and the link traversal is the listener hearing the song making an instantaneous evaluation on whether to allow the song to continue to play. The musicians in the metaphor are link placers. The link placers are able to place a link from an existing node, to a newly thereby created node. Each link has a specific weight. Moreover, the link placers can place a plurality of links from existing nodes, provided however that the sum of the weights of such links is equal to a previously determined number, which in some embodiments is fixed, and in some embodiments is one hundred.

To reiterate, the listeners in the metaphor are link traversers. The link traverser selects an initial node. The system then sums up the weights on all the outgoing links from that node to create a normalization constant. The system computes a link traversal probability of traversing each outgoing link by dividing the weights on that outgoing link by the normalization constant. The system selects an outgoing link to traverse based on the above link traversal probabilities. This is a reverse traversal in comparison to conventional art wherein each node suggests what the next node may be. In the present system and method, the node suggests the previous node.

In some embodiments, a link traversal represents listening to music. A fast link traversal represents skipping the music and a normal speed traversal represents listening to the music all the way to the end. The link traverser will either traverse the link at the link's natural pace which will strengthen the link and increase the weight on that link, or it will traverse the link quickly and that will weaken the link and reduce its weight.

In a first embodiment of the system and method, the weight adjustment of the traversed link is optimized by conventional support vector machine learning technology. In the present embodiment, the machine learning element determines how much to modify the weights on the links as a result of a normal or fast traversal in order to maximize the number of times that link-traverses traverse a link at normal pace.

Our time, the system weakens links to unvisited or rarely visited nodes in order to eliminate songs where that song is skipped and the next song is played normally. The pattern of one link traversal being fast and next being normal causes fusion of a first outgoing link from a first node to a second node whose corresponding traversal was at normal pace. This is done to optimize the fewest fast traversals over a link for the set of all link traversers.

A musician ranking subsystem compels a musician who seeks to sign up for the Internet web site to list three bands the musician would want to open for in a concert situation. Systems and methods according to the present invention then compile those responses and builds a vectors based on the popularity of the listed bands. According to principles of the present invention, the more artists who want to open for Band X, the more competition there will be to open for that band and the lower the probability of actually opening for them in the play lists provided by the present invention. The word “open” in the present context refers to having music play following the other music for which it “opens.”

As a band's music is increasingly cited by creating an outgoing link therefrom, that cited band's rank as a peer-reviewed band increases. The amount by which that cited band's rank increases may be dependant upon the rank of a band's citers. Intuitively, those bands that have a lot of value placed on them would be able to “transfer” their value to the bands they listed as wanting to open for. Accordingly, the votes are weighted based on how popular a certain band is with other bands and how popular those bands are with listeners. This vote is a weighted vote accounting for other bands and their opinion of a song/artist.

For example, a band may list that they want to open for the band, U2, because they are the most popular band in the world (therefore, more people would be exposed to their music) but not necessarily think that the U2 audience is the “best” audience. Such behavior is penalized by the present system because the chance of actually “opening” for U2 is determined by the number of bands seeking to so open for them. Moreover, as the U2 audience hears music that they do not like, they will skip over it, and that node/music will have the link to it weakened, until the node is unreachable and slips into oblivion, or at least into the periphery thus not being effectively available to listeners. This traversal embodiment represents a competitive classification by “experts,” that is, those owners of the entertainment content.

Popular bands are able to determine who they play after in the musician rankings because their inherent ranking earns them status and credibility in the musician ranking hierarchy. The method of the present embodiment is recursive and is continually updated based on musician classification as well as listener behavior.

One embodiment of the method of the present invention designates each musician or band a fixed weight to distribute among outgoing links for music that such an artist requests to “open” for. Another embodiment of the method of the present invention pertains particularly to unsigned bands because their validity derives from the listener behavior over time of hearing particular music or conversely skipping over it. An alternative embodiment focuses on the total number of plays or alternatively the total number of minutes played. This embodiment takes the total number of times a band has been fully played through and rank them against other bands accordingly. This gives a “one play, one vote” ranking and a sense of mass democracy. If enough people listen to a band, that makes them popular on the rankings. This can be combined with the recursive method where a base number of votes a band has is the number of plays rather than a fixed number. This means that every time a listener hears a song all the way through, or stops it in the middle, the method recursively readjusts the ranking of those musicians whose rank depends up the contribution from that particular song.

In another embodiment of the present invention, the method ranks musicians and bands according to the plays/stop ratios. Every time a band's songs are played, the method tracks the number of times the song is skipped (if any). Thus, a band whose song is skipped half the time would have a ratio percentage of 50%.

In another embodiment, the method of the current invention ranks musicians and bands according to the total length of song play, or the relative length of song play as against the total length of the given song. So that when the song is skipped, the method records the skipping action in relation to the length of the song, such that if a song is 1 minute long, and is always skipped at second 20, the ratio would be 33% for that song. The advantages of this design is that it gives the most user-driven data for the rankings as opposed to “one vote” rankings. The method favors the bands who have the “catchiest” songs, or the ones that grab listeners' attention at the beginning of the track, and that is what radio really cares about. This is used to strengthen or weaken connections made based on the previous embodiments.

The embodiments providing ranking based upon musician classification, user plays, play/stop ratio, total time played, and percentage played, are used in combination where a machine learning algorithm as described above could be used to effectively learn which combination of the above best predicts music that listeners choose to hear and that they rarely skip.

In one embodiment, a musicians' ranking is based partially on the “opening act” design with an emphasis on musician peer ranking, and partially on the user-driven ranking systems which actually measures how many people listen to a band, and for how long they listen. That would combine the “popular by association” ranking, and the “popular by listening behavior” ranking.

The embodiments described herein have mainly involved music however the system and method described herein can also be effective for a wide variety of entertainment or other similar content.

It is to be understood that the above-identified embodiments are simply illustrative of the principles of the invention. Various and other modifications and changes may be made by those skilled in the art which will embody the principles of the invention and fall within the spirit and scope thereof.

We claim:

1. An automated method for monitoring media recipient behavior, comprising:
providing a monitoring device to interface with a media-playing device;
monitoring media recipient behavior through the monitoring device; and
analyzing behavior data collected in the monitoring step with regard to a particular piece of media content to determine a commercial outcome.

2. The method of claim 1 wherein the monitoring device is a software application to be downloaded to the media-playing device.

3. The method of claim 1 wherein the monitoring device is a hardware device configured to interface with the media playing device.

4. The method of claim 1 further comprising the steps of establishing a connection from the monitoring device to a network; and
transmitting data from the monitoring device to a remote site for analysis.

5. The method of claim 1 wherein the method of monitoring further comprises monitoring media recipient behavior with regard to the particular piece of media content.

6. The method of claim 1 further comprising the step of transmitting the data to an analytic engine.

7. The method of claim 1 further comprising the step of providing media content to be played on the media-playing device where the media content is selected based on at least one influence factor.

8. The method of claim 7 wherein the influence factor comprises pre-existing media recipient behavior data.

9. The method of claim 1 wherein the analyzing step further comprises developing a rating for the particular piece of media content in response to media recipient behavior.

10. The method of claim 1 wherein the step of providing a monitoring device further comprises providing a plurality of monitoring devices each to one of a plurality of media recipients, and
wherein the monitoring step further comprises monitoring media recipient behavior of the plurality of media recipients, and
wherein the analyzing step further comprises analyzing the data of the plurality of media recipients to determine a potential commercial success of the particular piece of media content.

11. A system for discovering media content preferences, comprising:
at least one delivery channel for delivering media content to recipients;
a database of media content pieces to be delivered over the delivery channel, wherein each media content piece includes at least one link to at least one other media content piece in the database and a point value associated with the other media content piece;
a user preference device to accept at least one recipient preference,
whereby the system provides media content over the at least one delivery channel, the media content to include media content pieces selected according to the at least one recipient preference and links between the media content pieces stored in the database.

12. The system of claim 11 further comprising a plurality of delivery channels.

13. The system of claim 12 wherein the at least one recipient preference includes selection of delivery channel.

14. The system of claim 11 wherein each media content piece in the database has a weight value.

15. The system of claim 14 wherein the system assigns the weight value to a media content piece based on popularity of the media content piece.

16. The system of claim 11 wherein the at least one recipient preference further comprises genre.

17. The system of claim 11 wherein the at least one recipient preference further comprises at least one preferred media content piece.

18. The system of claim 11 wherein the point value in the database is assigned by a media creatro who uploaded the particular other media content piece.

19. The system of claim 11 wherein the user preference device further comprises a user monitoring component, the user monitoring component to monitor recipient behavior in response to media content delivered over the at least one delivery channel.

20. The system of claim 19 wherein the system adjusts the point value in response to recipient behavior associated with the other media content piece.
